(19) United States
(12) Patent Application Publication
(10) Pub. No.: US 2007/0001565 A1
(43) Pub. Date: Jan. 4, 2007

(54) Flat Display Device

(76) Inventor: Yeungki Kim, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 11/475,935

(22) Filed: Jun. 28, 2006

(30) Foreign Application Priority Data
Jun. 30, 2005 (KR) 2005-0058755

(51) Int. Cl. H01J 61/52

(52) U.S. Cl. 313/46

(57) ABSTRACT

A plastic chassis base may be employed in a flat display device including a circuit member. The plastic chassis base may include a plurality of plastic coupling members for receiving the circuit member at a back side of the plastic chassis base, supporting the circuit member away from the back surface of the chassis base and preventing the received circuit member from moving toward and away from the chassis base, and an electrically conductive film on a back surface of the plastic chassis base and a surface of the coupling member for grounding the circuit member.

### BACKGROUND OF THE INVENTION

1. Field of the Invention

The invention relates to a flat display device. More particularly, the invention relates to a flat display device, e.g., a plasma display device, including a coupling member provided at a rear surface of a chassis base made of, e.g., plastic, for securely fixing, e.g., a circuit board, to the chassis base. One or more aspects of the invention may simplify complicated fabrication processes for flat display devices, e.g., plasma display devices, caused by, e.g., boss-screw coupling and may also reduce vibration and noise of the flat display device.

2. Description of the Related Art

Flat display devices, e.g., plasma display devices, liquid crystal display devices (LCDs), electroluminescence display devices, field emission display devices, are being developed as substitutes for cathode ray tubes (CRTs). The different types of flat display devices have advantages and disadvantages. For example, in comparison with CRTs, plasma display devices can be fabricated with a slim structure and plasma display devices may enable relatively light-weight and/or thin displays having wide-viewing screens. In comparison with other flat panel displays, e.g., LCDs, plasma display devices do not require an active element, e.g., a transistor, and can ensure a wide viewing angle and high brightness.

Plasma display devices display images using plasma discharge phenomena, and, compared with other flat display devices, may easily realize complete digitization and a wide screen. A plasma display device may employ a plasma display panel (PDP) for realizing an image using a visible ray emitted from a fluorescent layer, which has been excited by an ultraviolet ray generated by plasma that may be created when a gas discharge occurs in discharge gas injected into a discharge space formed between two opposite substrates.

Elements required for displaying an image, e.g., driving circuits for driving electrodes of the PDP, may be attached to the PDP. A PDP having such a structure may achieve a gray scale required for displaying an image by controlling, e.g., a number of sustain discharge operations of the driving electrodes according to video data transmitted thereto. One approach for representing a gray scale is to employ an address and display period separated scheme (ADS) in which one frame to be driven is divided into a plurality of sub-fields having, e.g., different numbers of discharge operations. According to the ADS scheme, each sub-field may include a reset period for uniformly generating the discharge, an address period for selecting a discharge cell, and sustain and erase periods for representing values of the gray scale by controlling a number of discharge operations.

In such PDPs, each pixel may perform discharge operation(s) in a respective pixel area of the PDP. More particularly, e.g., a discharge operation may occur in a pixel area associated with a pixel when a voltage is applied to electrode(s) associated with the respective pixel, thereby generating plasma or excited atoms in the respective pixel area. Some of the power used for the plasma discharge operation may be converted into light, but much of the power may be converted into heat. As a result of such heat, a temperature of the PDP may rise and the increasing temperature may damage the PDP by, e.g., degrading or deforming fluorescent materials that may be employed in the PDP, or thermal expansion. Such degradation or deformation of the fluorescent materials may shorten a life span of the PDP. Thermal expansion may cause, e.g., a glass substrate of the PDP to expand, thereby subjecting the glass substrate to stress, which may result in breakage of the glass substrate.

A PDP may include a chassis base that may support the PDP and may reinforce the mechanical strength of the PDP. The chassis base may contact, e.g., the PDP or the driving circuit, thereby increasing a heat dissipation area of the PDP. That is, e.g., the chassis base may receive heat from the PDP or the driving circuit, and may dissipate the heat outside, e.g., out from the PDP and the plasma display device. The chassis base may uniformly distribute locally concentrated heat. The chassis base may be made from a material having superior heat conductivity, e.g., a metal such as aluminum.

Typically, a chassis may be fabricated by coupling a reinforcement member with the chassis base. The reinforcement member may reinforce the mechanical strength of the chassis base to reduce and/or prevent deformation of the chassis base when the chassis base is subjected to an external force. For example, the reinforcement member may reduce and/or prevent bending of the chassis base when the PDP is subjected to heat, thereby reducing and/or preventing such deformation of the PDP.

For driving the PDP, driving circuits may be distributed on one or more circuit boards together with a power supply. The circuit board may be spaced apart from the chassis base by, e.g., a boss formed on the chassis base, so that air can flow between the circuit board and the chassis base.

Driving circuit(s) and PDPs that require less power are being developed. Modules that can operate at low power level(s) and consume less power may generate less electromagnetic interference (EMI) and/or less heat. Thus, in such modules, e.g., an expensive thermally conductive chassis, e.g., an aluminum chassis, may be replaced with an inexpensive chassis, e.g., a chassis base made from plastic. Methods of integrating, e.g., coupling, such alternative chassis bases with flat panel displays are desired.

### SUMMARY OF THE INVENTION

The invention is therefore directed to a coupling member and flat display devices employing such a coupling member, which substantially overcome one or more problems due to limitations and disadvantages of the related art.

It is therefore a feature of embodiments of the invention to provide flat display devices, e.g., plasma display devices, in which a coupling member is integrally formed at a rear surface of a chassis base made, e.g., of plastic, and a metal thin film is coated on an inner surface of the coupling member for grounding a driving circuit, thereby reducing vibration and noise generated from the driving circuit and simplifying fabrication processes of the flat display device by eliminating a need for a conventional boss-screw coupling process.

It is therefore a separate feature of embodiments of the invention to provide alternative chassis bases, e.g., plastic chassis bases, and methods of forming an alternative chassis base that simplify fabrication of and/or reduce a costs associated with fabricating such alternative chassis bases and/or integrating such alternative chassis bases with other devices, e.g., integrating an alternative, e.g., lower cost, lighter, chassis base with a flat display device, e.g., a plasma display panel.

It is therefore a separate feature of embodiments of the invention to provide a coupling mechanism of a chassis base that is constructed while forming the coupling mechanism itself.

It is therefore a separate feature of embodiments of the invention to utilize a molding property of an alternative chassis base to fabricate a coupling mechanism for a chassis base.

It is a separate feature of embodiments of the invention to provide a coupling structure for the circuit board at the rear surface of the chassis base by utilizing the molding property of plastic, instead of coupling the circuit board to an upper portion of a boss by using a screw after installing the boss at the rear surface of the chassis base. In this case, the fabrication time for the plasma display device can be significantly reduced because processes for forming the boss and coupling the screw can be removed.

At least one of the above and other features and advantages of the present invention may be realized by providing a flat display device including a panel including first and second substrates facing each other, a chassis base made from plastic, the chassis base supporting the panel, being arranged at a back side of the panel, a coupling member provided on the chassis base, and a circuit member engaged by the coupling member, the circuit member including a driving circuit for driving electrodes formed on the panel.

The coupling member may include a base section connected to a back surface of the chassis base to support the circuit board away from the back surface of the chassis base and prevent the circuit member from moving toward the chassis base, and a hook section formed on the base section to hold the circuit member such that the circuit member is prevented from being released in a direction away from the chassis base. Along a direction parallel to the back surface of the chassis base, a thickness of the base section may be larger than a thickness of the support portion. The hook section may include a flexible portion and a support portion, the flexible portion may temporarily deform during coupling of the circuit member to the coupling member. The flexible portion may substantially extend along a direction parallel to the back surface of the chassis base, and the support portion may substantially extend along a direction perpendicular to the back surface of the chassis base such that along a direction perpendicular to the back surface of the chassis base, the hook section has a reverse-L sectional shape relative to the base section.

A cross-sectional shape of an end portion of the flexible portion in a direction perpendicular to the back surface of the chassis base may be one of rectangular, right-angled triangular and semi-circular. An electrically conductive thin film may be coated on an inner surface of the coupling member. The electrically conductive thin film may include metal. A plurality of coupling members may be provided and one of the plurality of coupling members may be provided at each corner of one circuit member, each coupling member may have two leg portions with each of the leg portions extending along a different side of the one circuit member such that along a plane parallel to the back-surface of the chassis base, the coupling member has a substantially L shaped structure.

A pair of coupling members for engaging two opposing sides of one circuit portion board may be provided such that along a plane parallel to the back-surface of the chassis base, the pair of coupling members may form of a figure “11”. The coupling member may be integrally formed with the chassis base through an injection molding process. A TCP, which may include a driving chip, may be provided for electrically connecting electrodes formed on the panel to the circuit portion. A protective member may be formed on the TCP for covering and protecting the TCP. The protective member may be equipped with a heat sink. A reinforcement member may be provided at the back surface of the chassis base corresponding to a position of the driving chip. The reinforcement member may be integrally formed with the chassis base through an injection molding process.

At least one of the above and other features and advantages of the present invention may be realized by providing a coupling member employable for connecting a circuit member to a plastic chassis base of a flat display device, the coupling member including a base section on a back surface of the plastic chassis base to support at least a portion of the circuit member away from the back surface of the chassis base and to prevent the portion of the circuit member from moving toward the plastic chassis base, and a hook section on the base section to hold at least a portion of the circuit member such that the circuit member is prevented from being released in a direction away from the plastic chassis base, wherein the coupling member is formed of a plastic.

The coupling member may include a receiving groove for receiving a portion of the circuit member, the receiving groove may be defined by facing surfaces of the base section and the hook section of the coupling member. At a boundary between the base section and the hook section and along a depth direction of the receiving groove, a thickness of the base section may be larger than a thickness of the support portion. The hook section may include a flexible portion and a support portion, the flexible portion may temporarily deform during coupling of the circuit member to the coupling member.

At least one of the above and other features and advantages of the present invention may be realized by providing plastic chassis base employable in a flat display device including a circuit member, the plastic chassis base may include a plurality of plastic coupling members for receiving the circuit member at a back side of the plastic chassis base, supporting the circuit member away from the back surface of the chassis base and preventing the received circuit member from moving toward and away from the chassis base, and an electrically conductive film on a back surface of the plastic chassis base and a surface of the coupling member for grounding the circuit member.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates an exploded perspective view of an exemplary embodiment of a flat display device according to one or more aspects of the invention;

FIG. 2 illustrates a first exemplary embodiment of a coupling member according to one or more aspects of the invention;

FIG. 3 illustrates a second exemplary embodiment of a coupling member according to one or more aspects of the invention;

FIG. 4 illustrates a third exemplary embodiment of a coupling member according to one or more aspects of the invention;

FIG. 5 illustrates a perspective view of an exemplary coupling member in a state in which the coupling member is coupled to a circuit portion, according to a first embodiment of the present invention;

FIG. 6 illustrates a plan view of the exemplary coupling member shown in FIG. 5;

FIG. 7 illustrates a sectional view of the exemplary coupling member shown in FIG. 5, along line A-A shown in FIG. 6;

FIG. 8 illustrates a perspective view of an exemplary embodiment of an arrangement of the coupling member shown in FIG. 2, in a state in which the coupling member is coupled to a circuit portion;

FIG. 9 illustrates a plan view of the exemplary arrangement of the coupling member shown in FIG. 8; and

FIG. 10 illustrates a sectional view of the exemplary arrangement of the coupling member shown in FIG. 8, along line B-B shown in FIG. 9.

### DETAILED DESCRIPTION OF THE INVENTION

Korean Patent Application No. 2005-0058755, filed Jun. 30, 2005 in the Korean Intellectual Property Office, and entitled: “Plasma Display Device,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

In accordance with embodiments of the invention, different materials may be used to provide different functions for a display panel and its associated driving circuit in order to optimize the support structure in the display. For example, a lightweight, strong material, e.g., plastic, may be used for the chassis base, a conductive sheet may be provided between the chassis base and the panel, bosses may provide electrical communication, e.g., ground, between a circuit portion supported by the chassis base and the conductive sheet, the conductive sheet may also serve as a heat sink, resilient connectors may be provided between the bosses and the conductive sheet, etc. As used herein, “conductive” is to mean “electrically conductive,” and anything that is to be thermally conductive will be explicitly so-called.

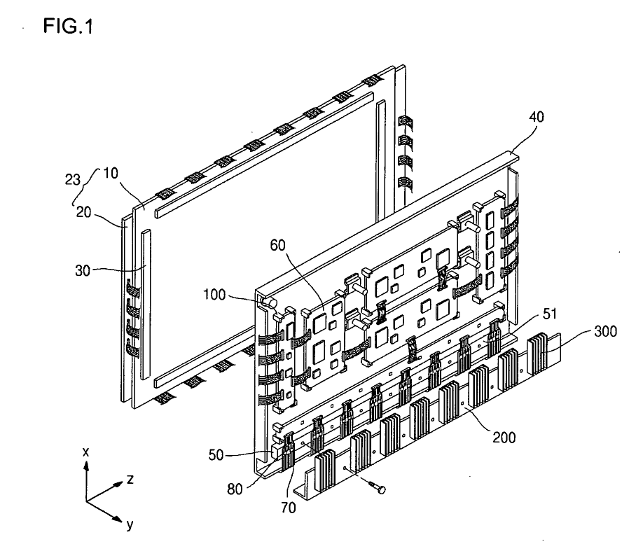

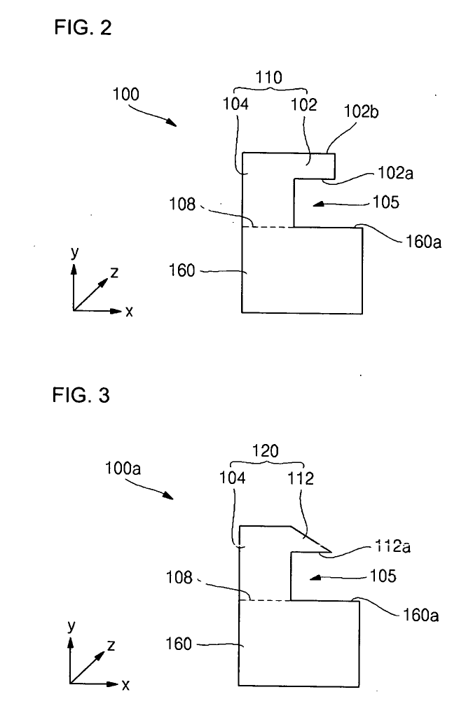

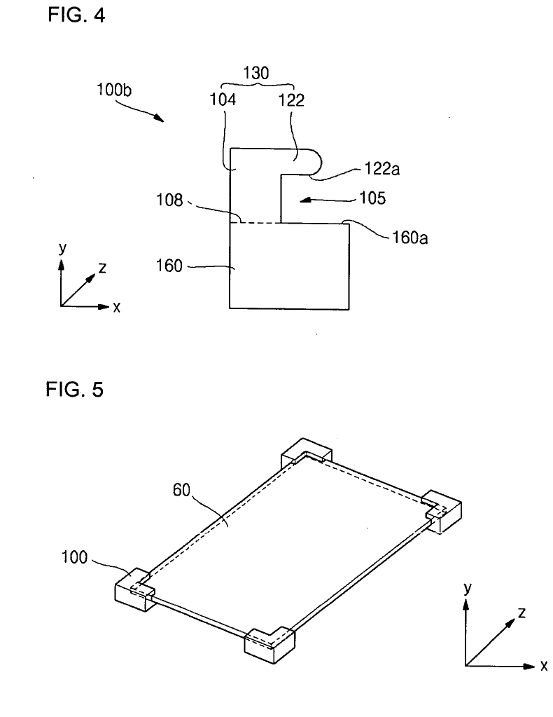

FIG. 1 illustrates a schematic exploded perspective view of an exemplary embodiment of a flat display apparatus according to the invention; FIG. 2 illustrates a perspective view of an exemplary embodiment of a coupling member according to a first embodiment of the invention; FIG. 3 illustrates a plan view of the coupling member shown in FIG. 2; and FIG. 4 illustrates a sectional view of the coupling member shown in FIG. 2, along line A-A of FIG. 3.

As shown in FIG. 1, a flat display device 1 may include a panel 23, a chassis base 40, a coupling member 100, a circuit portion 60, e.g., a circuit board, an electrical coupler 70 and a heat sink 300. The chassis base 40 may be made from, e.g., plastic, may be aligned at a rear portion of the panel 23, and may support the panel 23. The circuit portion 60 may include one or more circuit boards. The coupling member 100 may be provided at a rear surface 41 of the chassis base 40 and may couple the circuit portion 60 to, e.g., the chassis base 40. The electrical coupler 70 may be one or more tape carrier packages TCP, may include an integrated circuit (IC) chip 80, e.g., a driving circuit, and may electrically connect the panel 23 to the circuit portion 60.

A protective member 200, e.g., a protective plate, may overlap and cover at least a portion of the electrical coupler 70 to protect the electrical coupler 70. The heat sink(s) 300 may be arranged on the protective member 200. A reinforcement member 50 may be provided at a rear lower portion of the chassis base 40.

The panel 23 may include a first substrate 10 and a second substrate 20. The first substrate 10 and the second substrate 20 may be arranged parallel to one another with a space between them. A plurality of connecting electrodes (not shown) may be provided in a vicinity of the panel 23. The connecting electrodes may be formed, e.g., at an outer portion of a sealing section (not shown) along an outer peripheral portion of the panel 23 to connect a plurality of electrodes, e.g., address electrodes and sustain electrodes, which may be arranged all over the first and second substrates 10 and 20 of the panel 23, to an IC chip 80, e.g., a driving circuit.

For example, in embodiments of the invention involving a plasma display device rather than another type of flat display device, the first substrate 10 may be made from, e.g., a transparent material, e.g., glass, having a predetermined thickness and, although not shown, may have, e.g., address electrodes, barrier ribs and/or a fluorescent layer arranged thereon. The barrier ribs may at least partially define discharge cells where gas discharge may occur.

In the case of a plasma display device, the second substrate 20 may be made from, e.g., a transparent material, e.g., soda glass, and, although not shown, may have, e.g., scan electrodes, sustain electrodes, a dielectric layer and/or a passivation layer arranged thereon. The dielectric layer may protect the scan and sustain electrodes. The passivation layer may protect the dielectric layer. The barrier ribs may be arranged on the second substrate rather than the first substrate and/or any combination thereof. The invention does not limit the position of the barrier ribs.

In flat panel devices employing one or more aspects of the invention, the chassis base 40 may be provided at a rear portion of the panel 23 and may help reduce and/or prevent the panel 23 from bending or deforming.

The chassis base 40 may be fabricated, e.g., by rolling or casting a metal, e.g., Al or Fe. However, as mentioned above, a chassis base 40 made from metal may be relatively more expensive and may have a relatively higher weight, which may make fabrication of such a chassis base relatively difficult and/or may cause loud noise to be generated from the chassis base 40 when the chassis base 40 is subjected to vibration.

Embodiments of the invention may employ a chassis base 40 made from, e.g., a strong, light weight, and relatively less expensive material, e.g., plastic. For example, a chassis base 40 made from, e.g., plastic, may be lighter in weight, may generate less noise, and may be less expensive to fabricate relative to a chassis base 40 made of aluminum.

The chassis base 40 may be attached to the panel 23 by a coupling mechanism 30, e.g., a double-sided tape. In a case where the chassis base 40 is made from metal, a double-sided tape along with a heat conductive member (not shown) may be interposed between the panel 23 and the chassis base 40 to fix the panel 23 to the chassis base 40. The heat conductive member may be provided between the panel 23 and the chassis base 40 made from metal to effectively transfer heat generated from the panel 23 to the chassis base 40. That is, in the case of a chassis base 40 made of metal, heat generated from the panel 23 may be transferred to the chassis base 40 through the heat conductive member so that heat dissipation may occur through the chassis base 40.

In embodiments of the invention having a chassis base 40 made from a non-conductive or substantially non-conductive material, e.g., plastic, the coupling member 30 may be interposed between the chassis base 40 and the panel 23 to fix the panel 23 to the chassis base 40. For example, in contrast to cases employing a chassis base 40 made from metal, a heat conductive member need not be provided between the chassis base 40 made from plastic, and the panel 23. In the case of a chassis base made from strong, light-weight and non-conductive material, e.g., plastic, because the chassis base 40 has no or low heat conductivity, heat dissipation may not be effectively performed through the chassis base 40 even if the heat is concentrated on the chassis base 40 through a heat conductive medium. Thus, in embodiments of the invention employing such a chassis base 40 made from, e.g., a non-conductive or substantially non-conductive material, the panel 23 may be attached to the chassis base 40 via a coupling mechanism 30, e.g., double-sided tape without a heat conductive member for dissipating heat, and a predetermined gap may be formed between the chassis base 40 and the panel 23 such that the gap may serve as a funnel for dissipating heat.

In embodiments of the invention, e.g., plastic may be used as a material for the chassis base 40 and plastic may include, e.g., polyester resin or polycarbonate resin. Polyester resin may be reinforced with glass fiber, i.e., fiber reinforced plastic FRP and such FRP may also be used to form the chassis base 40, according to one or more aspects of the invention. Molding techniques may enable the manufacture of FRPs having a strength similar to that of steel. For example, polycarbonate resin, i.e., engineering plastic, may have superior mechanical and/or heat-resistant characteristics, e.g., self-extinguishing and harmless features. Polyester resin and polycarbonate resin are thermosetting resins having superior heat-resistant characteristics, which may be advantageous against heat generated from the panel 23 or the IC chip 80, and superior mechanical characteristics, which may be advantageous for supporting the panel 23. However, any material that is, e.g., light-weight, easy to process, heat-resistant, less expensive and/or strong may be employed and the invention does not limit the kind of material, e.g., plastic, used for the chassis base 40.

The chassis base 40 may be fabricated through, e.g., an injection molding process. With an injection molding process, a mold having a structure corresponding to that of the chassis base 40 may be fabricated and melted material, e.g., plastic, may be injected into the mold and solidified therein. Accordingly, the chassis base 40 may be fabricated within a relatively short period of time at a relatively low cost through, e.g., the injection molding process.

The reinforcement member 50 may be provided, e.g., at a rear lower portion of the chassis base 40. The reinforcement member 50 may be individually attached to the chassis base 40. The reinforcement member 50 may be integrally formed with the chassis base 40. The reinforcement member 50 may be aligned higher than a lower end portion of the rear surface 41 of the chassis base 40 and a surface 51 of the reinforcement member may be planarized. The reinforcement member 50 may support the chassis base 40 in such a manner that the chassis base 40 may be prevented from being deformed by heat or an external impact applied thereto. In embodiments of the invention, the IC chip 80 may be positioned on the surface 51 of the reinforcement member 50 such that the IC chip 80, e.g., driving circuit, may make contact with the protective member 200 having the heat sink(s) 300, thereby dissipating heat generated from the IC chip 80.

The coupling member 100 may be provided at a rear surface of the chassis base 40 to couple the chassis base 40 with the circuit portion 60 such that the circuit portion 60 may be fixed to the chassis base 40. Although it may be possible to allow the circuit portion 60 to be in direct contact with the rear surface of the chassis base 40, in such cases, heat generated from the circuit portion 60 may not dissipate away from the chassis base 40 to the outside, and/or loud noise may be generated when one or both of the chassis base 40 and the circuit portion 60 vibrates.

In embodiments of the invention, the circuit portion 60 may be arranged at a predetermined distance apart from the chassis base 40 by the coupling member 100. Heat may be guided away from the chassis base 40 to the outside of the panel 23 and flat panel device 1 through the gap formed between the circuit portion 60 and the chassis base 40. The coupling member 100 may be individually coupled to the rear surface 41 of the chassis base 40. The coupling member 100 may be integrally formed with the chassis base 40. For example, the coupling member 100 may be integrally formed with the chassis base 40 through the injection molding process.

FIGS. 2, 3 and 4 are sectional views illustrating exemplary coupling members 100, 100a, 100b, according to first, second and third exemplary embodiments of the invention. In the following description the first exemplary embodiment of the coupling member 100 will be first described in detail, and only differences between the first exemplary embodiment and the other exemplary embodiments will be described thereafter.

As shown in FIG. 2, the coupling member 100 may include a base section 160 and a hook section 110. The base section 160 and the hook section 110 may define a receiving groove 105 for receiving a circuit portion 60. The base section 160 may be coupled to a surface, e.g., the rear surface 41, of the chassis base 40 and/or integrally extend from the surface, e.g., a rear surface 41, of the chassis base 40. The base section 160 may support the circuit portion 60 away from, e.g., the rear surface 41 of the chassis base 40 such that the circuit portion 60 may be prevented from moving toward and/or contacting the chassis base 40. The hook section 110 may hold the circuit portion 60 and may prevent the circuit portion 60 from moving away from the surface, e.g., the rear surface 41, of the chassis base 40.

FIGS. 3 and 4 showing exemplary coupling members 100a, 100b illustrate other exemplary embodiments of the hook section 120, 130, respectively. As shown in FIGS. 2 through 4, the hook section 110, 120, 130 may have a substantially reverse-L shaped structure relative to the base section 160 and/or along a x-y plane. A first leg of the reverse-L shaped structure may extend along the x-direction and a second leg of the reverse-L shaped structure may extend along the y-direction.

The hook section 110, 120, 130 may include a flexible portion 102, 112, 122, respectively, and a support portion 104. The flexible portion 102, 112, 122 of the hook section 110, 120, 130, respectively, may extend substantially along an x-direction, e.g., substantially parallel to the rear surface 41 of the chassis base 40. The support portion 104 may extend substantially along a y-direction, e.g., substantially perpendicular to the rear surface 41 of the chassis base 40.

As shown in FIGS. 2 through 4, a cross-sectional shape of an end portion of the flexible portion 102, 112, 122, along a direction perpendicular to the chassis base 40, may be, e.g., rectangular, right-angled triangular, and semi-circular, respectively. The invention is not, however, limited the exemplary sectional shapes of the exemplary flexible portions 102, 112 or 122 shown in FIGS. 2 through 4.

A respective surface 102a, 112a, 122a of the flexible portion 102, 112, 122 facing a surface 160a of the base section 160 may together with the surface 160a define the receiving groove 105.

To couple or arrange a circuit portion 60 to the coupling member 100, 100a, 100b, the respective flexible portion 102, 112 or 122 may be flexed or deformed such that an end portion of the circuit portion 60 may be, e.g., snapped into the receiving groove 105. More particularly, e.g., in the case of the exemplary embodiment illustrated in FIG. 2, the circuit portion 60 may originally be pressed against an outer surface 102b of the flexible portion 102 and may press the flexible portion 102 towards the chassis base 40 and then, after the circuit portion 60 is received by the receiving groove 105, the flexible portion 102 may return to its original position, e.g., substantially parallel to the rear surface 41 of the chassis base 40.

In embodiments of the invention, the flexible portion 102, 112, 122 may elastically deform, e.g., move toward the chassis base 40, and then return to its initial position after the circuit portion 60 is coupled to the coupling member 100. When the circuit portion 60 is coupled, e.g., received in the receiving groove 105, the coupling member 100 secures the circuit portion 60 in place, preventing the circuit portion 60 from moving away from the chassis base 40.

Embodiments of the invention may enable removal of the circuit portion 60 without damaging the coupling member. For example, to remove the circuit portion 60 coupled to the coupling member 100, when a sufficient force is applied, e.g., the circuit portion 60 is pulled with a sufficient force, the flexible portion 102, 112, 122 may elastically deform, e.g., move away from the chassis base 40, and then return to its initial position after the circuit portion 60 is released from the receiving groove 150. The force sufficient for removing the circuit portion 60 should be at least high enough such that the circuit portion 60 may not pop out or be released from the coupling means 100 when subjected to a lesser force.

In embodiments of the invention, the flexible portion 102, 112 or 122 may have a thickness sufficient for supporting and holding the circuit portion 60 received, e.g., in the receiving groove 105, in place, preventing the circuit board 60 from being separated from the coupling member 100, and allowing the flexible portion 102, 112 or 122 to be sufficiently deformed in, e.g., the downward direction, for installing the circuit portion 60.

When a circuit portion 60 is coupled to the coupling member 100, 100a, 100b, a weight of the circuit portion 60 may be supported by the coupling member 100. The base section 160 may support the circuit board 60 from a lower portion of the circuit portion 60. To support the weight of the circuit portion 60, a thickness of the base section 160 along the x-direction, e.g., parallel to the chassis base 40, may be larger than a thickness of the support portion 104 along the x-direction. The thickness of the support portion 104 along the x-direction may be such that the weight of the circuit portion 60 subjected thereto may be supported and/or movement the circuit portion 60 may be prevented. In embodiments of the invention, at a boundary 108 between the base section 160 and the support portion 104, along a depth direction of the groove, e.g., the x-direction, a thickness of the support portion 104 may be less than a thickness of the base portion 160. The boundary 108 may be where the base section 160 is connected to the support portion 104 or, in embodiments where the base section 160 and the support portion 104 are integrally formed, the boundary 108 may correspond to a plane at which the thickness of the coupling member 100 changes.

As shown in FIG. 7, a conductive thin film 400, e.g., a metal thin film, may be coated on an inner surface 106 of the coupling member 100. The conductive thin film 400 may also be coated on the rear surface 41 of the chassis base 40. The inner surface 106 of the coupling member 100 may also include the respective surface 102a, 112a, 122a of the flexible portion 102, 112, 122 and the facing surface 160a of the base section. The conductive thin film 400 may be in electrical contact with the circuit portion 60. The conductive thin film 400 may be provided to ground circuitry, e.g., the IC chip 80, e.g., driving circuit. Chassis bases 40 made of metal may be electrically connected to the circuit board with a boss provided at the rear surface 41 of the chassis base 40, thereby grounding an IC chip 80, e.g., driving circuit, mounted on the circuit portion 60.

In embodiments of the invention including a chassis base 40 made of a non-conductive material, e.g., plastic, a separate structure or mechanism may be provided to ground the IC chip 80, e.g., the driving circuit. Thus, in embodiments of the invention, the conductive thin film 400 may be, e.g., coated on the inner surface of the coupling member 100, and may serve to electrically connect the circuit portion 60 to ground when the circuit portion 60 is coupled to the coupling member 100, thereby grounding the IC chip 80, e.g., the driving circuit.

A wiring structure electrically connected to the conductive thin film 400 coated on the inner surface of the coupling member 100 may be formed at the rear surface 41 of the chassis base 40. The conductive thin film 400 may include highly conductive materials, e.g., Al or Cu having superior electric conductivity. However, the invention does not limit the materials for the conductive thin film 400 to Al or Cu.

A first exemplary arrangement of the coupling member 100 will be described below. In the description of this exemplary embodiment, the first embodiment of the coupling member 100 will be used to describe the first exemplary arrangement. However, one or more aspects of the invention are not limited to the coupling member 100, e.g., coupling members 100a, 100b according to the second and third embodiments described above may also be employed.

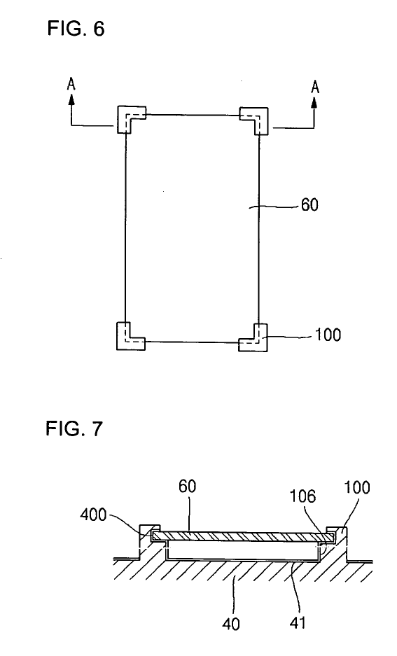

As shown in FIG. 5, a plurality of coupling members 100, e.g., four coupling members 100, may be provided at corners of the circuit portion 60, e.g., circuit board, respectively, for coupling the circuit portion 60 to the chassis base 60. As shown in FIG. 6, one coupling member 100 may be provided at each corner of the circuit portion 60.

In embodiments of the invention, some or all of the coupling members 100 coupling one circuit portion 60 the chassis base 40 may be substantially L-shaped along an x-z plane such that each coupling member extends along at least two sides of the circuit portion 60. In embodiments of the invention, a first leg of the L-shaped structure extends along the x-direction at a first side of the circuit portion 60 and a second leg of the L-shaped structure extends along the z-direction at a second side of the circuit portion 60.

As discussed above each coupling member 10 may include a base section 160 and a hook portion 110, 120,130, and the hook portion 110, 120, 130 may have a substantially reverse-L shaped structure along the x-y or the z-y plane. For example, the support portion 104 may extend along the y-direction and the respective flexible portion 102, 112, 122 may extend along the x-direction or the z-direction. In embodiments of the invention, the coupling member 100 may completely surround the circuit portion 60 and may include slits on, e.g., the respective flexible portion 102, 112, 122 to help deformation of the flexible portion during installation of one circuit portion 60.

FIG. 7 illustrates a sectional view of the exemplary coupling member shown in FIG. 5, along line A-A shown in FIG. 6, in state where a circuit potion 60 is coupled to the coupling member 100. To couple the circuit portion 60 to the coupling member 100 having the above structure, the circuit portion 60 may be set on the respective flexible portion 102, 112, 122 of the coupling member 100 and the circuit board 60 may be pressed toward, e.g., the rear surface 41 of the chassis base 40, thereby temporarily deforming the respective flexible portion 102, 112, 122 and fixing the circuit portion 60 to the coupling member 100. After the circuit portion 60 is received by the receiving groove 105 that may be formed by the combination of the hook section 110, 120, 130 and the respective base section 160 of the coupling member 100, the circuit portion 60 is securely fixed to the coupling member 100 so long as external force capable of deforming the flexible portion 102, 112 or 122 is not applied to the circuit portion 60.

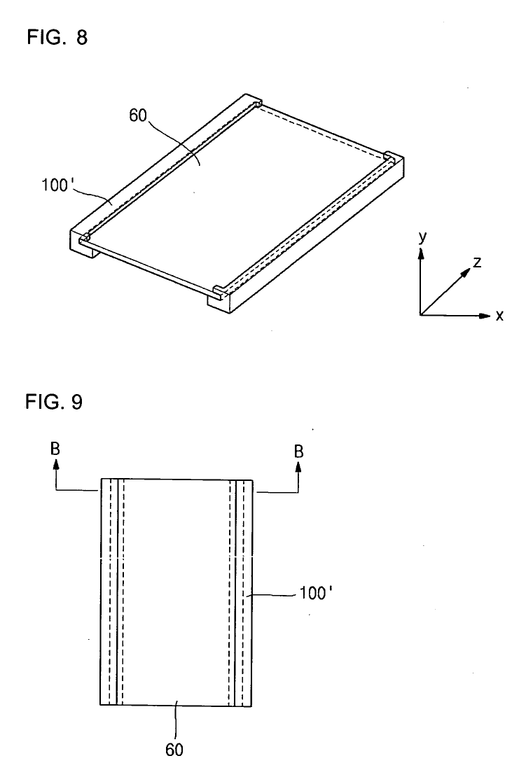

A second exemplary arrangement of the coupling member 100′ will be described with reference to FIGS. 8-10. The coupling member 100′ substantially corresponds to the coupling member 100 described above in relation to FIGS. 2 and 5-7, but having a shape along the x-z plane that substantially corresponds to a respective edge of the circuit portion 60 to be received by the respective coupling member 100. For example, for a circuit portion 60 having a rounded edge, the coupling member 100′ may have a shape along the x-z plane that is curved or rounded. For a circuit portion 60 having a straight edges, the coupling member 100′ may have a shape that extends substantially parallel to the respective edge. More particularly, a shape of the respective receiving groove 105 may correspond to a shape of the respective edge of the circuit portion to be received by the receiving groove 105. In the description of this exemplary embodiment, the first embodiment of the coupling member 100 will be used to describe the second exemplary arrangement. However, one or more aspects of the invention are not limited to the coupling member 100, e.g., coupling members 100a, 100b according to the second and third embodiments described above may also be employed.

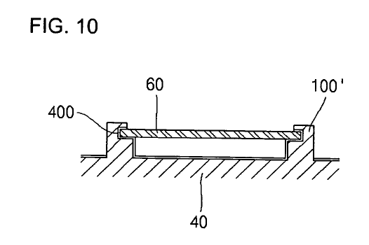

FIG. 8 illustrates a perspective view of an exemplary embodiment of an arrangement of the coupling member shown in FIG. 2, in a state in which the coupling member is coupled to a circuit portion, FIG. 9 illustrates a plan view of the exemplary arrangement of the coupling member shown in FIG. 8, and FIG. 10 illustrates a sectional view of the exemplary arrangement of the coupling member shown in FIG. 8, along line B-B shown in FIG. 9.

In this exemplary embodiment, a coupling member may be arranged on two or more sides, e.g., opposing sides or every side, of the circuit portion 60. As shown in FIGS. 8-10, two coupling members 100′ may be provided at two opposing sides of one circuit portion 60. When viewed from the rear side of the chassis base 40, the coupling members 100′ may be arranged to form of a figure “11” and surround two opposing lateral sides of the circuit portion 60. In embodiments of the invention, the coupling member 100′ may extend completely along a side of the circuit portion 60 or only a portion of the side of the circuit portion 60, and in some embodiments a plurality of coupling portions may be spaced apart along a same side of the circuit portion 60.

To couple a circuit portion 60 to the coupling member 100′ having such a structure, the circuit potion 60 may be slid along a direction corresponding to the side and parallel to the chassis base 40 of the circuit portion 60 to be engaged by the coupling member 100′. For example, the circuit portion 60 may be inserted into receiving grooves 105 defined, e.g., by the base section 160 and the respective hook section 110, 120, 130 of the coupling member 100′ by pushing the circuit portion 60 in a direction parallel to the chassis base 40, e.g., direction along x-z plane, thereby fixing the circuit portion 60 to the coupling member 100′. Once the circuit portion 60 is inserted into the receiving grooves 105, the circuit portion 60 can be securely fixed to the coupling member 100′ as long as external force capable of deforming the flexible portion 102, 112 or 122 is not applied to the circuit board 60. In embodiments of the invention in which the circuit portion 60 may be coupled to the coupling member 100 by sliding and without flexing or deforming the flexible portion 102, 112, 122, the flexible portion 102, 112, 122 may be less flexible than embodiments in which the circuit portion 60 presses against and temporarily deforms the flexible portion 102, 112, 122.

The circuit portion(s) 60 may include a power supply board, a sustain drive board, an X control board, a scan board and a scan buffer board. The power supply board may supply power to the IC chip 80, e.g., the driving circuit, and the panel and may be equipped with an AC/DC converter for converting an AC voltage into an DC voltage. The sustain drive board may generate a sustain signal while synchronizing with a signal of a timing controller and may send the sustain signal to sustain electrodes. The X control board may be provided with an intelligent power module (IPM), a timing control, and signal input terminals. The X control board may include a circuit section for processing data. The scan board may generate a scan signal while synchronizing with the signal of the timing controller and may send the scan signal. The scan buffer board may arrange data to be inputted into the scan electrodes. The IC chip 80, e.g., driving circuit, may be arranged on the rear portion of the chassis base and may be connected to the electrodes formed on the panel 23 so as to drive the electrodes. In order to transmit the electric signal of the IC chip 80, e.g., driving circuit, to each driving electrode, the IC chip 80, e.g., the driving circuit, may be connected to the driving electrodes through the electric coupler 70, e.g., TCP, or other signal lines.

The electric coupler 70 may serve as a signal line and may be fabricated in the form of a flexible printed circuit (FPC). In a state in which a middle part of the electrical coupler 70 extends toward an outer peripheral portion between the panel 23 and the chassis base 40 with a predetermined margin, both ends of the electrical coupler 70 may be connected to the circuit portion 60 coupled with the chassis base 40 and the panel 23. Accordingly, the middle part of the electrical coupler 70 may be damaged if it makes contact with other articles when the panel 23 is coupled with the chassis base 40 or if the panel 23 coupled with the chassis base 40 is moved. Protective plates 200 may be provided at a terminal end portion of the panel 23 to protect the electrical coupler 70 from such damage.

The protective members 200 may be coupled to an end portion of the chassis base 40 and/or the reinforcement member 50 provided in the vicinity of the end portion of the chassis base 40 by means of a coupler, such as a screw. The protective member 200 may include heat sink(s) 300, which may be arranged on the protective member 200. Because the IC chip 80, e.g., driving circuit, mounted on the electric coupler 70 may generate heat, the heat sink(s) 300 may be provided on the protective member 200 to dissipate the heat generated from the IC chip 80, e.g., driving circuit. In addition, a heat conductive medium can be interposed between the protective plate 200 and the IC chip 80, e.g., driving circuit, for improving heat conductivity therebetween. The heat conductive medium may include graphite or silicon.

As described above, in embodiments of the flat display device, e.g. plasma display device, the chassis base may be made from a strong, non-conductive or low conductive, light weight material, e.g., plastic resin, so that the flat display device may be lightweight, relatively low cost and may reduce and/or prevent vibration and/or noise generated from, e.g., the driving circuit. Embodiments of the invention separately provide a flat display panel that may include a coupling member integrally formed with a surface, e.g., rear surface, of the chassis base to securely fix the circuit board to the chassis base, thereby simplifying complicated fabrication processes for the plasma display device that may be caused by, e.g., a boss-screw coupling, and reducing vibration and noise.

Exemplary embodiments of the invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A flat display device, comprising:
a panel including first and second substrates facing each other;
a chassis base made from plastic, the chassis base supporting the panel, and being arranged at a back side of the panel;
a coupling member provided on the chassis base; and
a circuit member engaged by the coupling member, the circuit member including a driving circuit for driving electrodes formed on the panel.

2. The flat display device as claimed in claim 1, wherein the coupling member comprises:
a base section connected to a back surface of the chassis base to support the circuit board away from the back surface of the chassis base and prevent the circuit member from moving toward the chassis base; and
a hook section formed on the base section to hold the circuit member such that the circuit member is prevented from being released in a direction away from the chassis base.

3. The flat display device as claimed in claim 2, wherein the hook section includes a flexible portion and a support portion, the flexible portion temporarily deforming during coupling of the circuit member to the coupling member.

4. The flat display device as claimed in claim 3, wherein along a direction parallel to the back surface of the chassis base, a thickness of the base section is larger than a thickness of the support portion.

5. The flat display device as claimed in claim 4, wherein the flexible portion substantially extends along a direction parallel to the back surface of the chassis base, and the support portion substantially extends along a direction perpendicular to the back surface of the chassis base such that along a direction perpendicular to the back surface of the chassis base, the hook section has a reverse-L sectional shape relative to the base section.

6. The flat display device as claimed in claim 5, wherein a cross-sectional shape of an end portion of the flexible portion in a direction perpendicular to the back surface of the chassis base is one of rectangular, right-angled triangular and semi-circular.

7. The flat display device as claimed in claim 1, wherein an electrically conductive thin film is coated on an inner surface of the coupling member.

8. The flat display device as claimed in claim 7, wherein the electrically conductive thin film includes metal.

9. The flat display device as claimed in claim 1, further comprising a plurality of the coupling members and one of the plurality of coupling members is provided at each corner of one circuit member, each coupling member has two leg portions with each of the leg portions extending along a different side of the one circuit member such that along a plane parallel to the back-surface of the chassis base, the coupling member has a substantially L shaped structure.

10. The flat display device as claimed in claim 1, wherein a pair of the coupling members is provided and the pair of coupling members engage two opposing sides of one circuit member such that along a plane parallel to the back-surface of the chassis base, the pair of coupling members form a figure “11”.

11. The flat display device as claimed in claim 1, wherein the coupling member is integrally formed with the chassis base through an injection molding process.

12. The flat display device as claimed in claim 1, further comprising:
a TCP including a driving chip and electrically connecting electrodes formed on the panel to the circuit member; and
a protective member formed on the TCP for covering and protecting the TCP.

13. The flat display device as claimed in claim 12, wherein the protective member is equipped with a heat sink.

14. The flat display device as claimed in claim 12, wherein a reinforcement member is provided at the back surface of the chassis base corresponding to a position of the driving chip.

15. The flat display device as claimed in claim 14, wherein the reinforcement member is integrally formed with the chassis base through an injection molding process.

16. A coupling member employable for connecting a circuit member to a plastic chassis base of a flat display device, the coupling member comprising:
a base section on a back surface of the plastic chassis base to support at least a portion of the circuit member away from the back surface of the chassis base and to prevent the portion of the circuit member from moving toward the plastic chassis base; and
a hook section on the base section to hold at least a portion of the circuit member such that the circuit member is prevented from being released in a direction away from the plastic chassis base, wherein the coupling member is formed of a plastic.

17. The coupling member as claimed in claim 16, further comprising a receiving groove for receiving a portion of the circuit member, the receiving groove being defined by facing surfaces of the base section and the hook section of the coupling member.

18. The coupling member as claimed in claim 17, wherein at a boundary between the base section and the hook section and along a depth direction of the receiving groove, a thickness of the base section is larger than a thickness of the support portion.

19. The coupling member as claimed in claim 17, wherein the hook section includes a flexible portion and a support portion, the flexible portion temporarily deforming during coupling of the circuit member to the coupling member.

20. A plastic chassis base employable in a flat display device including a circuit member, the plastic chassis base comprising:
a plurality of plastic coupling members for receiving the circuit member at a back side of the plastic chassis base, supporting the circuit member away from the back surface of the chassis base and preventing the received circuit member from moving toward and away from the chassis base; and
an electrically conductive film on a back surface of the plastic chassis base and a surface of the coupling member for grounding the circuit member.
